(19) United States
(12) Patent Application Publication
(10) Pub. No.: US 2012/0125208 A1
(43) Pub. Date: May 24, 2012

(54) AUTOMATIC BREAD-MAKER

(75) Inventors: Teruaki Taguchi, Tottori-shi (JP); Takashi Watanabe, Tottori-shi (JP); Yasuyuki Ito, Tottori-shi (JP); Kazuya Yano, Tattori-shi (JP)

(73) Assignees: SANYO CONSUMER ELECTRONICS CO., LTD., Tottori-shi, Tottori (JP); SANYO ELECTRIC CO., LTD., Moriguchi-shi, Osaka (JP)

(21) Appl. No.: 13/388,614

(22) PCT Filed: Aug. 24, 2010
(86) PCT No.: PCT/JP2010/064219

§ 371 Date: Feb. 2, 2012

(30) Foreign Application Priority Data
Aug. 25, 2009 (JP) 2009-194122
Aug. 25, 2009 (JP) 2009-194125

(51) Int. Cl. A47J 37/01

(52) U.S. Cl. 99/348

(57) ABSTRACT

The disclosed automatic bread-maker (1) is provided with a bread container (50) into which the bread-making starting materials are introduced, a baking chamber (40) that is provided within a main body (10) and that accepts the bread container (50), a blade-rotating axle (52) provided at the bottom of the bread container (50), a pulverizing blade (54) mounted on the blade-rotating axle (52), a kneading blade (70) disposed above the pulverizing blade (54), and a motor (60) that applies torque to the blade-rotating axle (52). A depression (44) is formed on the bottom of the bread container (50) so as to surround the blade-rotating axle (52), and the pulverizing blade (54) rotates within the depression (55).

### TECHNICAL FIELD

The present invention is related to an automatic bread-maker for use mainly in general households.

### BACKGROUND ART

Commercially available bread-makers for household use are typically configured such that a bread container in which bread ingredients are put is placed in a baking chamber, the bread ingredients inside the bread container being mixed and kneaded by using a mixing/kneading blade, and after a fermentation process, baked into bread, by using the bread container as a baking pan. An example of such baking machines is disclosed in Patent Literature 1.

Sometimes, optional ingredients such as raisins and nuts are added to the bread ingredients to bake bread with optional ingredients. Patent Literature 2 discloses an automatic bread-maker equipped with means for automatically feeding optional bread ingredients such as raisins, nuts, or cheese.

### Citation List

### Patent Literature

Patent Literature 1: JP-A-2000-116526

Patent Literature 2: Japan Patent No. 3191645

### SUMMARY OF INVENTION

### Technical Problem

Conventionally, bread making needs to be started by preparing flour made by grinding grains of cereal such as wheat and rice, or ready-mixed flour made of such flour and various auxiliary ingredients mixed together. Even when there are cereal grains (typically rice) available at hand, it is not easy to make bread directly from such cereal grains. The present invention has been made in view of the above problems, and an object of the present invention is to provide an automatic bread-maker equipped with a mechanism that is convenient for making bread directly from cereal grains, and to make bread making easier to work on.

### Solution to Problem

To achieve the above object, according to the present invention, an automatic bread-maker includes: a bread container in which bread ingredients are put; a baking chamber which is provided inside a body and accommodates the bread container; a blade rotation shaft which is provided at a bottom portion of the bread container; a grinding blade which is fitted to the blade rotation shaft; a mixing/kneading blade which is arranged above the grinding blade; and a motor which imparts a rotational force to the blade rotation shaft. Here, a recess is so formed in a bottom portion of the bread container as to surround the blade rotation shaft and the grinding blade rotates inside the recess.

With this structure, it is possible to produce bread ingredients inside the bread container by putting cereal grains in the bread container and grinding them with the grinding blade. Thereafter, mixing/kneading of the bread ingredients is carried out by the mixing/kneading blade, and the procedure can further proceed in the bread container to fermentation and baking processes. It is possible to bake bread in the bread container from cereal grains ground in the same bread container. Thus, in contrast to a structure in which cereal grains are first ground in a container and then shifted to the bread container, this structure is free from volume loss of cereal grains resulting from some of the cereal grains being left in the container without moving to the bread container. Furthermore, it is possible to leave the grinding blade and the mixing/kneading blade inside the bread container from the start of the grinding of cereal grains until the end of baking operation, and this makes the automatic bread-maker easy to handle. Moreover, since the grinding blade rotates inside the recess formed in the bottom portion of the bread container, it is possible to minimize the amount of cereal grains scattering outside the bread container.

In the automatic bread-maker structured as described above, the grinding blade may be unrotatably attached to the blade rotation shaft, the mixing/kneading blade may be fitted to the blade rotation shaft such that the mixing/kneading blade rotates above the recess, and, between the mixing/kneading blade and the blade rotation shaft, there may be provided a clutch which couples the mixing/kneading blade and the blade rotation shaft to each other or uncouples the mixing/kneading blade and the blade rotation shaft from each other.

With this structure, it is possible to uncouple the mixing/kneading blade from the blade rotation shaft in grinding cereal grains, and this makes it possible to grind the cereal grains efficiently by making only the grinding blade rotate at high speed.

In the automatic bread-maker structured as described above, the clutch may be a unidirectional clutch which couples the mixing/kneading blade and the blade rotation shaft to each other when the blade rotation shaft rotates in one direction, and which uncouples the mixing/kneading blade and the blade rotation shaft from each other when the blade rotation shaft rotates in a direction opposite to said one direction.

With this structure, it is possible to impart or not to impart torque to the mixing/kneading blade just by changing the rotation direction of the blade rotation shaft, and this makes the automatic bread-maker easy to handle.

In the automatic bread-maker structured as described above, a disc which conceals the recess may be combined with the mixing/kneading blade.

With this structure, the disc stops the dough from going into the recess, and this helps avoid formation of a recess-shaped protrusion in the bottom of bread. In addition, the provision of the disc helps prevent the cereal grains from jumping upward after hitting the grinding blade.

The automatic bread-maker structured as described above may further include a dome-shaped cover which is fitted to the blade rotation shaft, the cover covering the grinding blade and having the mixing/kneading blade formed on an external surface thereof, such that the cover is accommodated in the recess.

With this structure, the grinding blade grinds cereal grains inside the cover, and this prevents the cereal grains from scattering outside the bread container during the grinding process. Furthermore, since the cover is accommodated in the recess and does not protrude from the bottom portion in the bread container, no large trace of the cover is left in the bottom of bread.

In the automatic bread-maker structured as described above, the grinding blade may be unrotatably attached to the blade rotation shaft, and, between the cover and the blade rotation shaft, there may be provided a clutch which couples the cover and the blade rotation shaft to each other or uncouples the cover and the blade rotation shaft from each other.

With this structure, the mixing/kneading blade can be uncoupled from the blade rotation shaft when cereal grains are ground, and this makes it possible to grind the cereal grains efficiently by rotating only the grinding blade at high speed.

In the automatic bread-maker structured as described above, the clutch may couple the cover and the blade rotation shaft to each other when the blade rotation shaft rotates in one direction, and may uncouple the cover and the blade rotation shaft from each other when the blade rotation shaft rotates in a direction opposite to said one direction.

With this structure, it is possible to impart or not to impart torque to the mixing/kneading blade provided on the external surface of the cover just by changing the rotation direction of the blade rotation shaft, and this makes the automatic bread-maker easy to handle.

In the automatic bread-maker structured as described above, between an outer peripheral portion of the cover and an internal surface of the recess, there may be formed a clearance which allows passage of bread ingredients therethrough, and the cover may have formed therein a window through which a space inside the cover and a space outside the cover communicate with each other.

With this structure, it is possible to create a circulation in which mixture of cereal grains and liquid present above the recess enters the recess through the clearance, the mixture is then moves from the recess into the cover, where the cereal grains are ground by the grinding blade, and then moves out of the cover through the window back to above the recess. This helps grind cereal grains with high efficiency.

### Advantageous Effects of Invention

According to the present invention, it is possible to bake bread by using cereal grains at hand, and thus there is no need of buying cereal flour as a bread ingredient. In the case of using rice, bread can be baked by using rice grains of any polishing rate from brown to white. And, since the processes from the grinding of cereal grains to the baking of bread can be all carried out in the bread container placed inside the baking chamber, there is less risk of undesired mixing of foreign matter into dough. Furthermore, in contrast to a structure in which cereal grains are first ground in a container and then shifted into the bread container, this structure is free from loss associated with such shift, in which some of the cereal grains may stick to the container to be left therein. Since the grinding blade and the mixing/kneading blade are placed inside the bread container from beginning to end, it is easy to handle them; since the grinding blade rotates inside the recess at the bottom portion of the bread container, it is possible to minimize the amount of cereal grains scattering out of the bread container. Furthermore, with the structure in which the cover is accommodated in the recess, it is possible to grind the cereal grains inside the cover, and this helps prevent the cereal grains from scattering out of the bread container and thus makes it easier to grind the cereal grains. Moreover, since the cover is accommodated in the recess and does not protrude from the bottom portion in the bread container, no large trace of the cover is left in the bottom of bread.

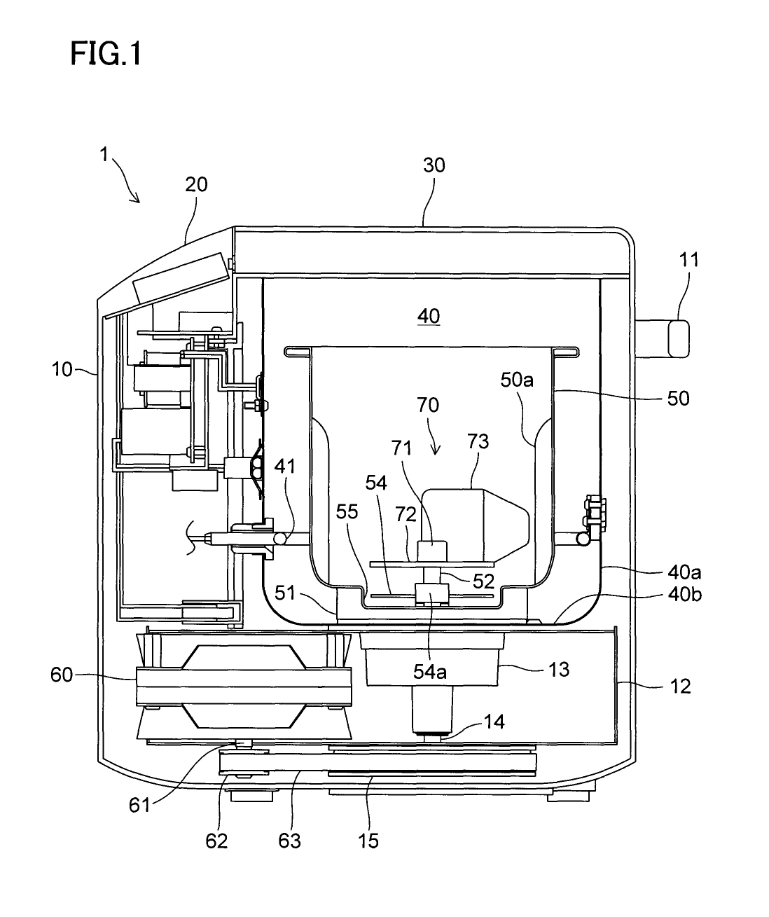

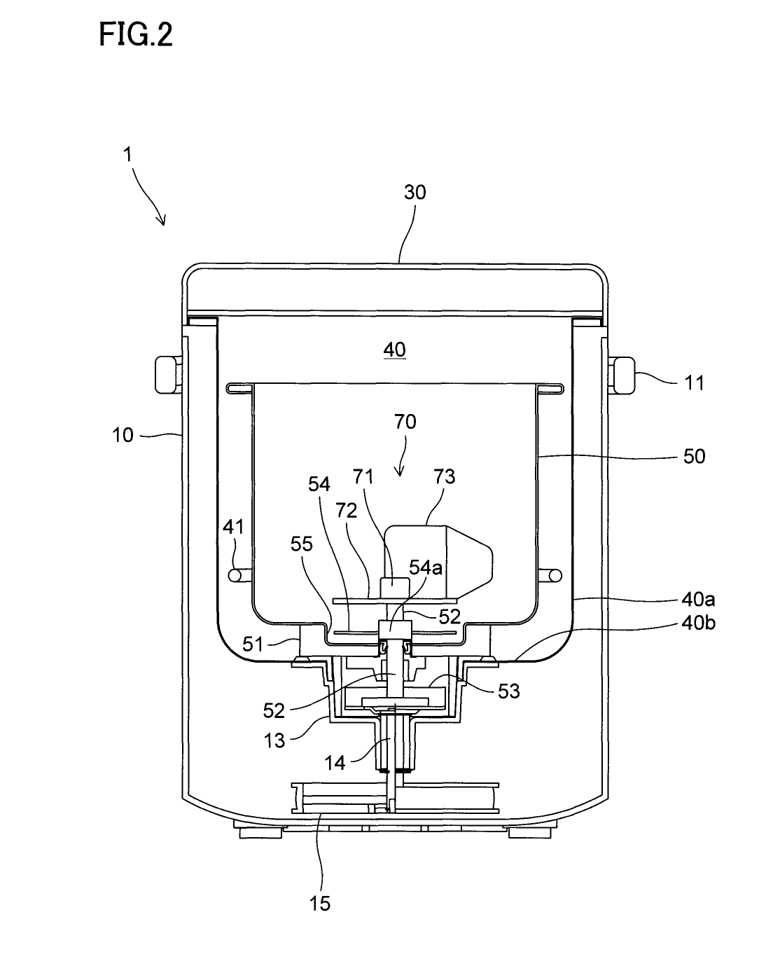

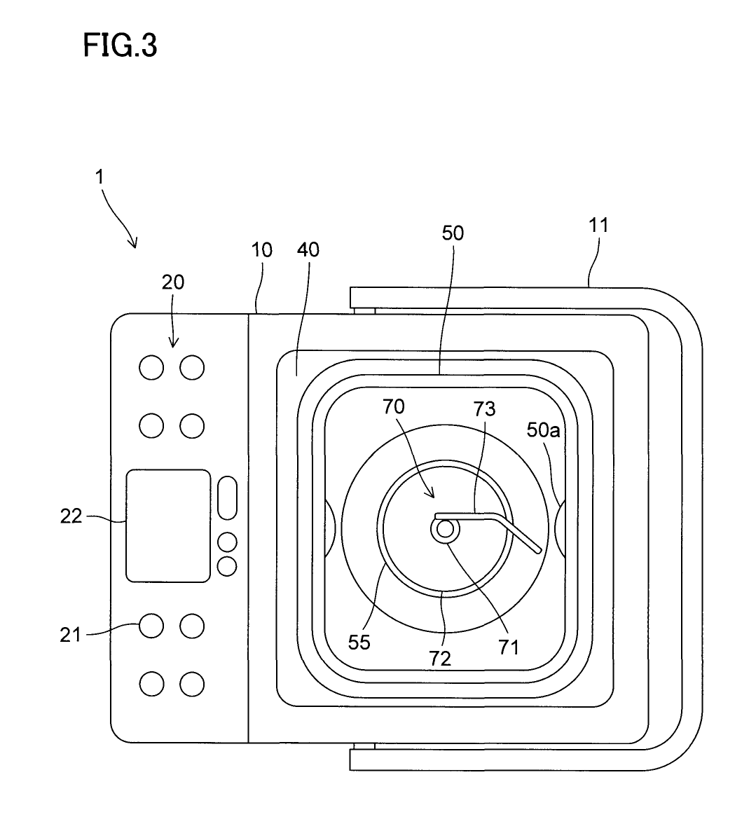

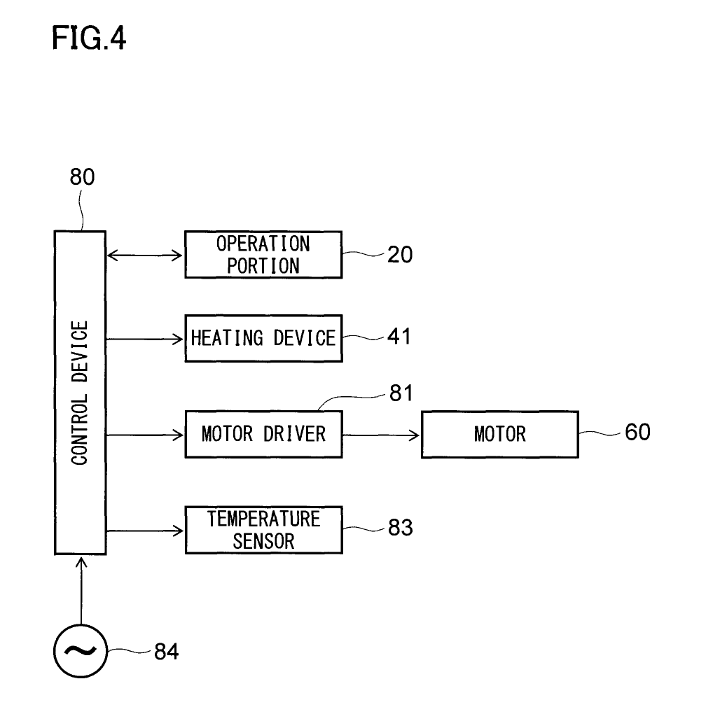

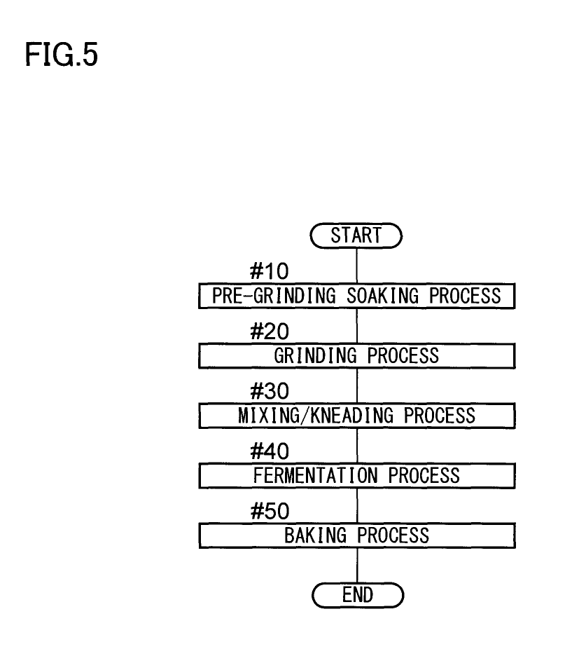

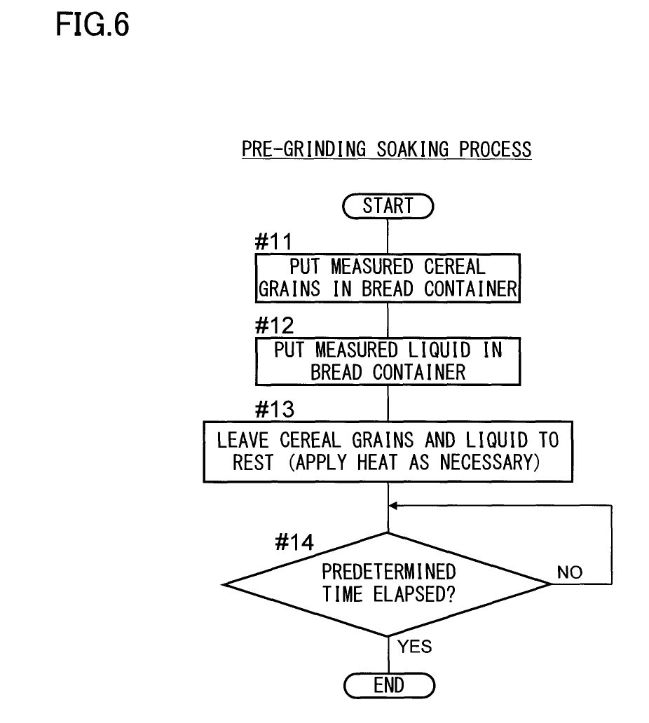

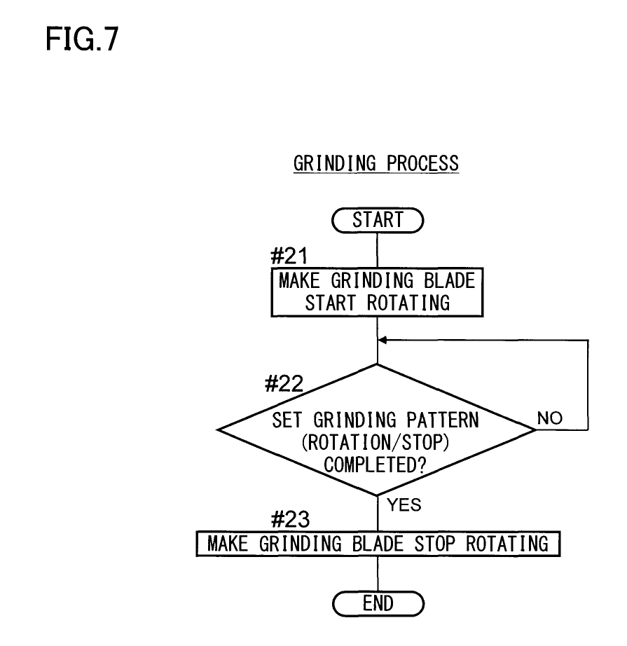

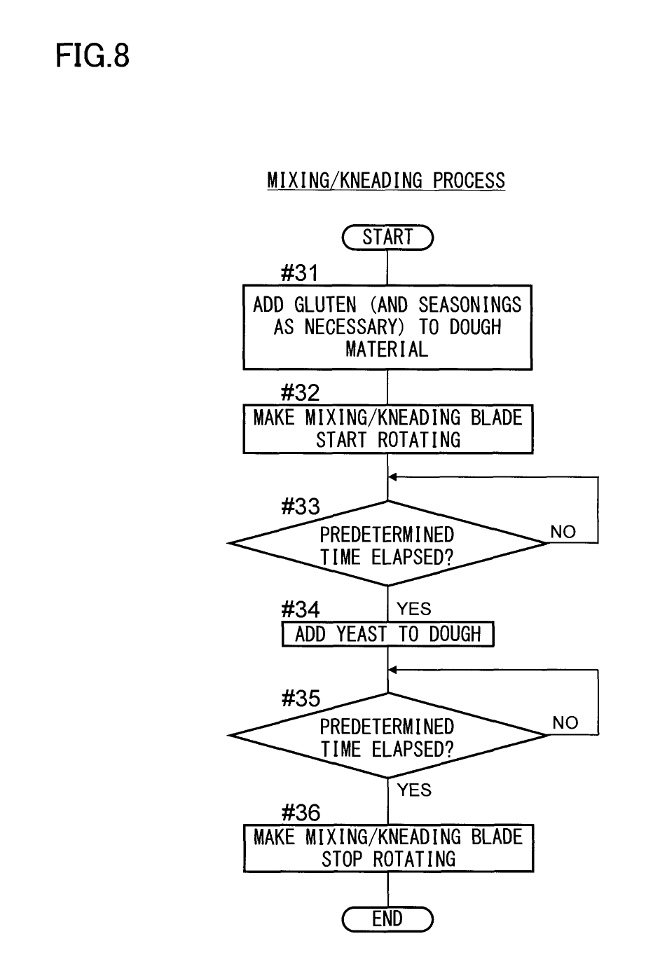

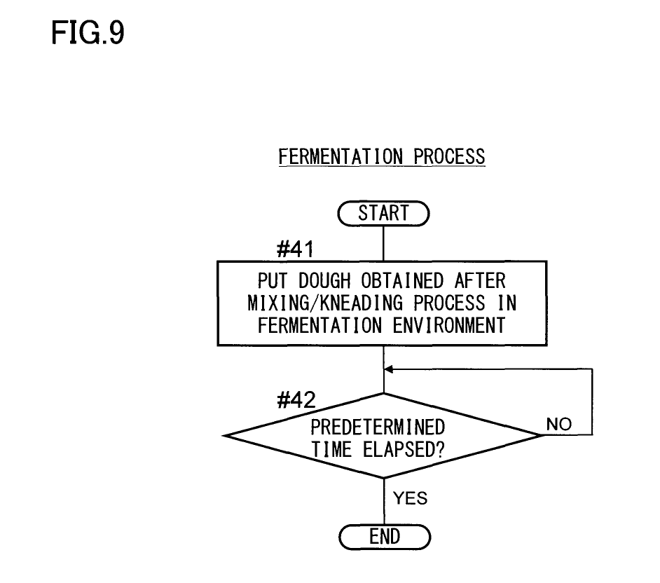

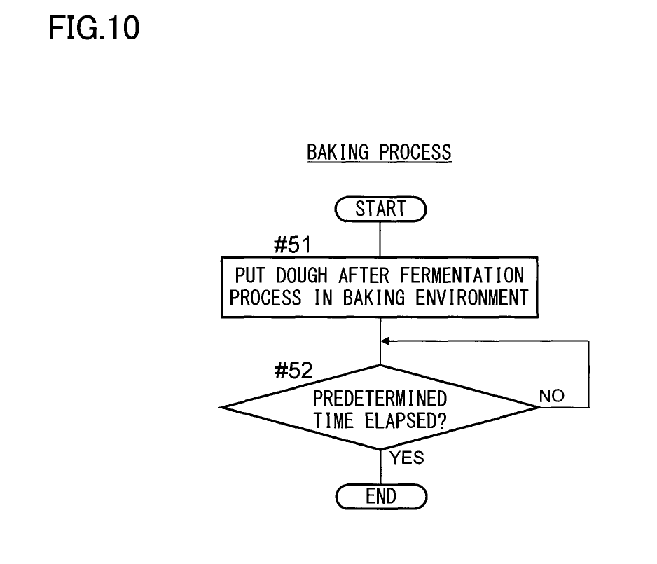

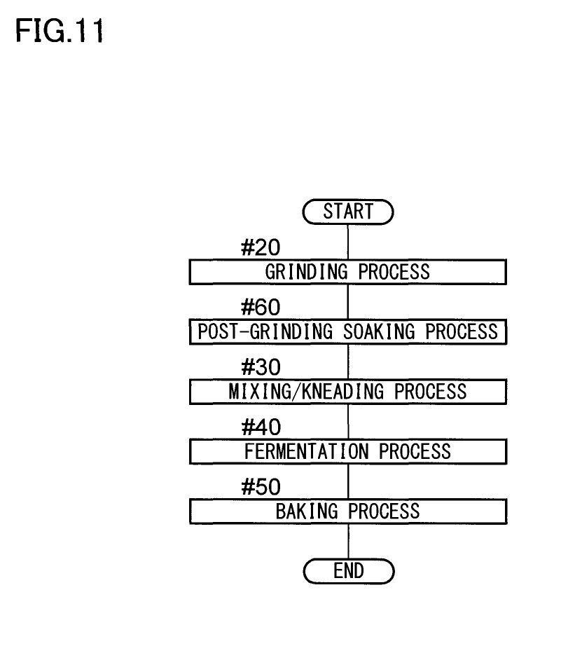

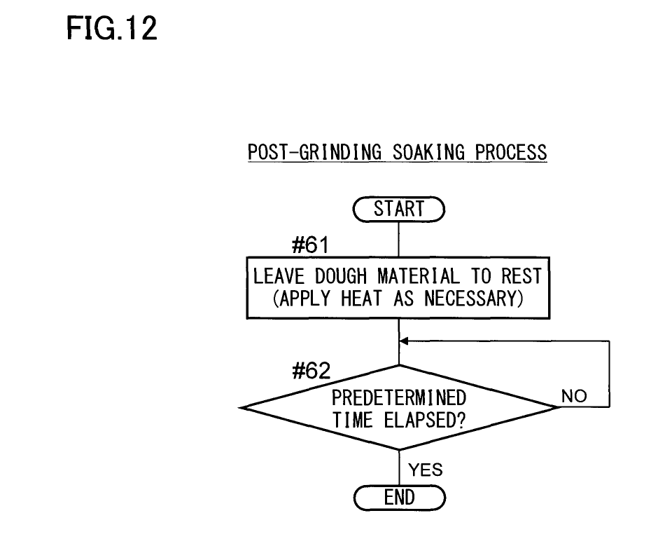

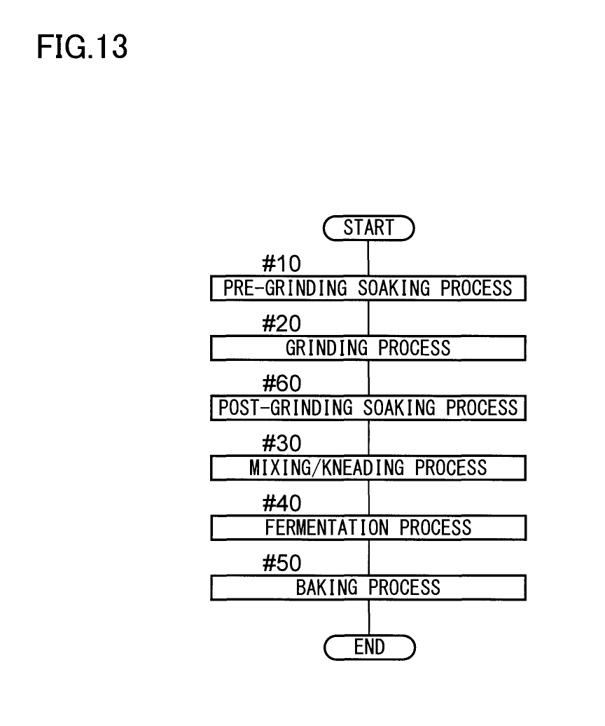

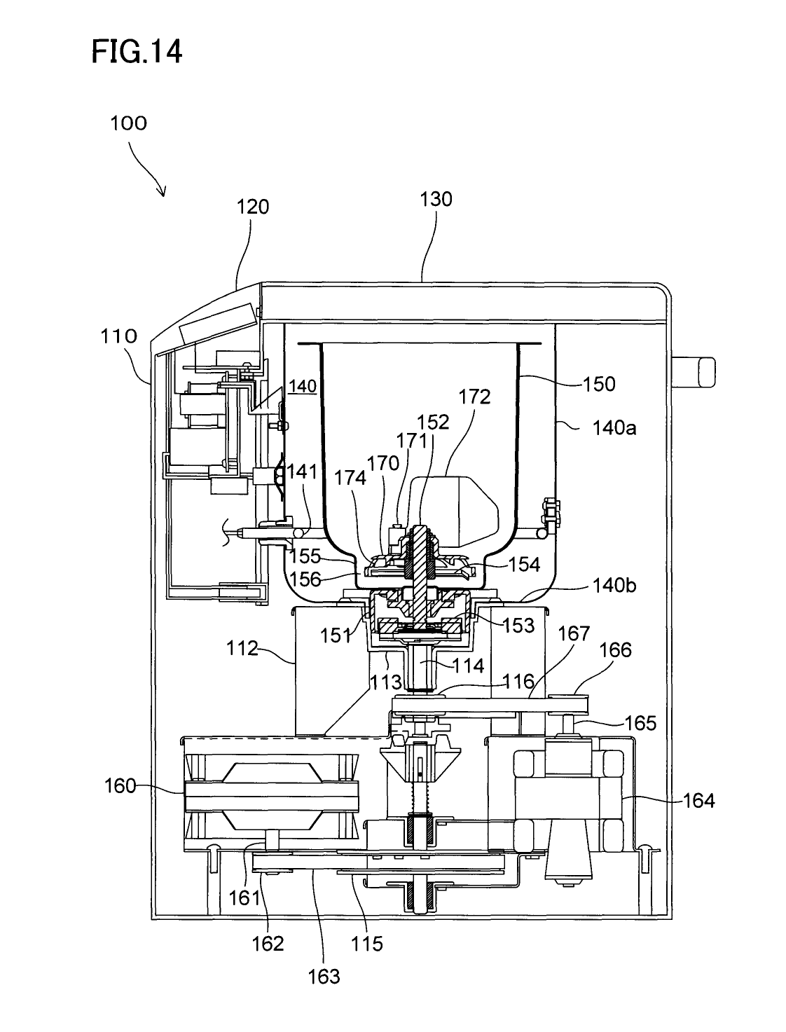

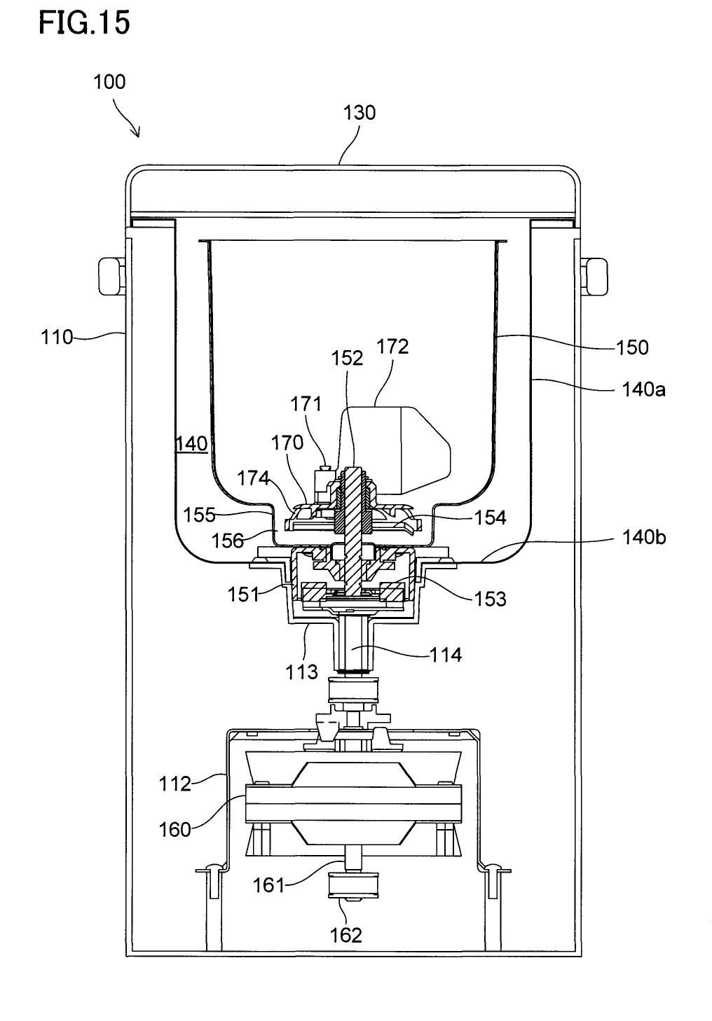

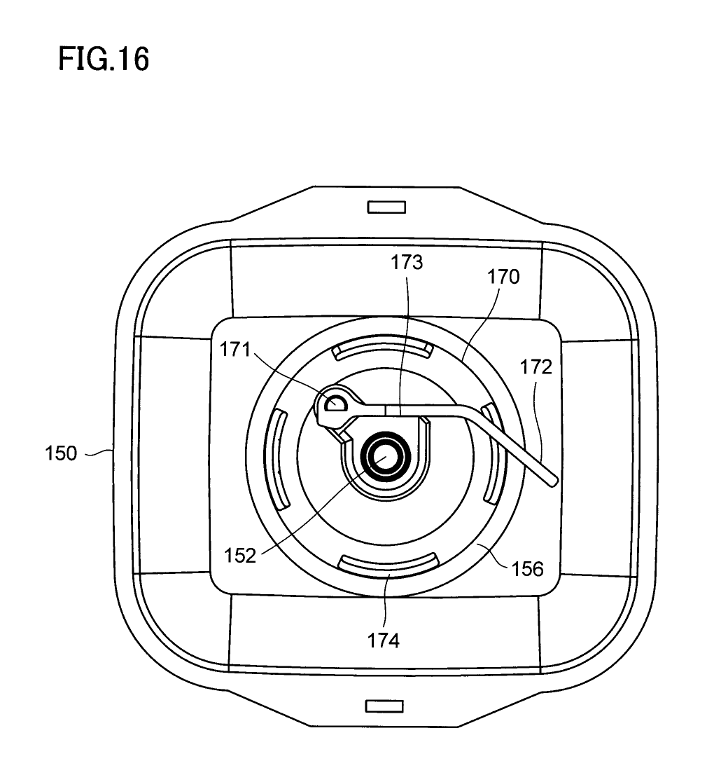

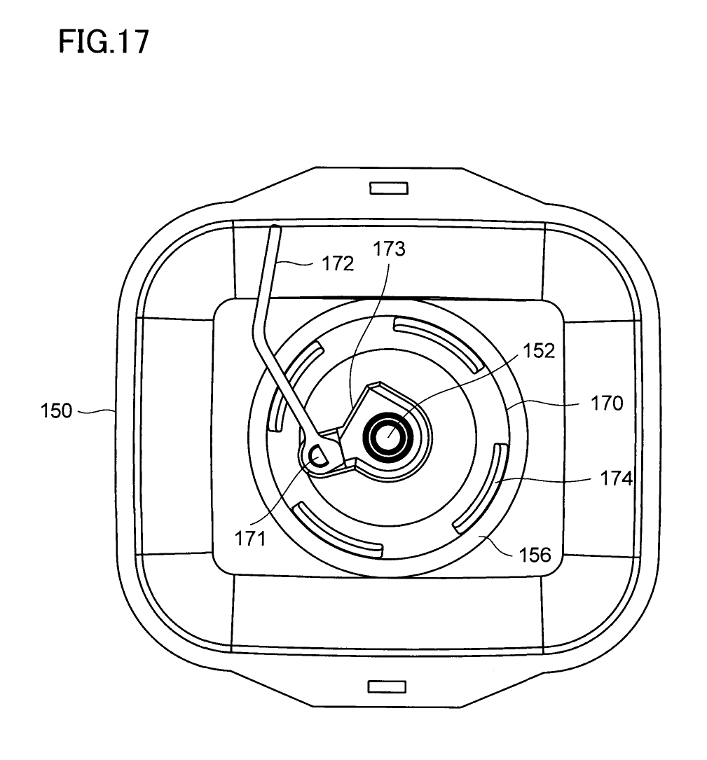

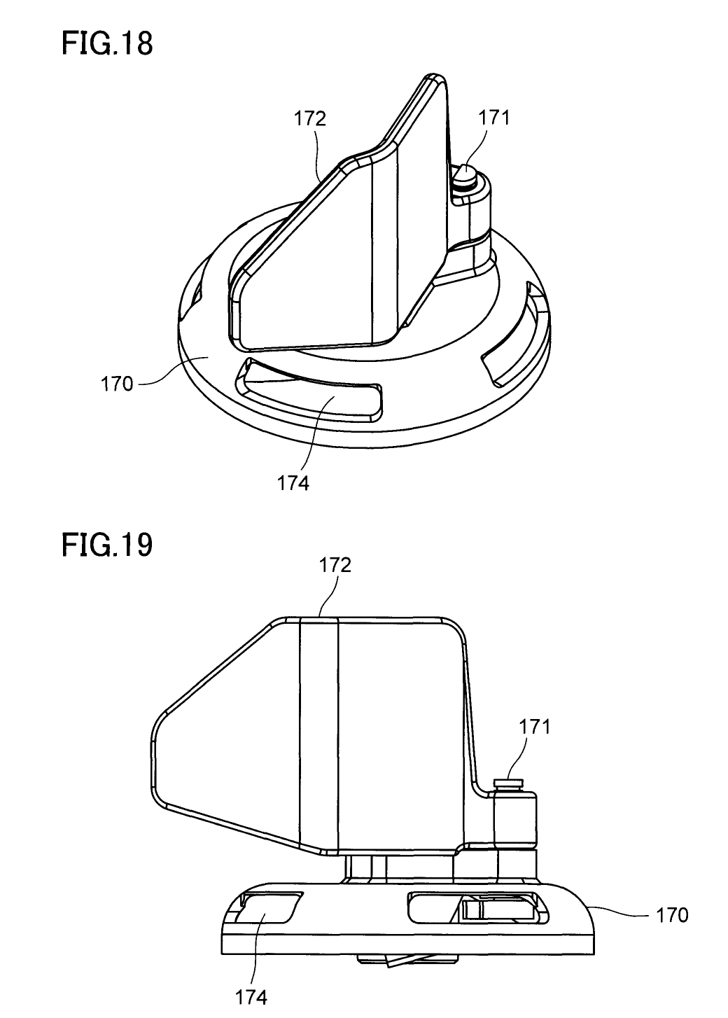

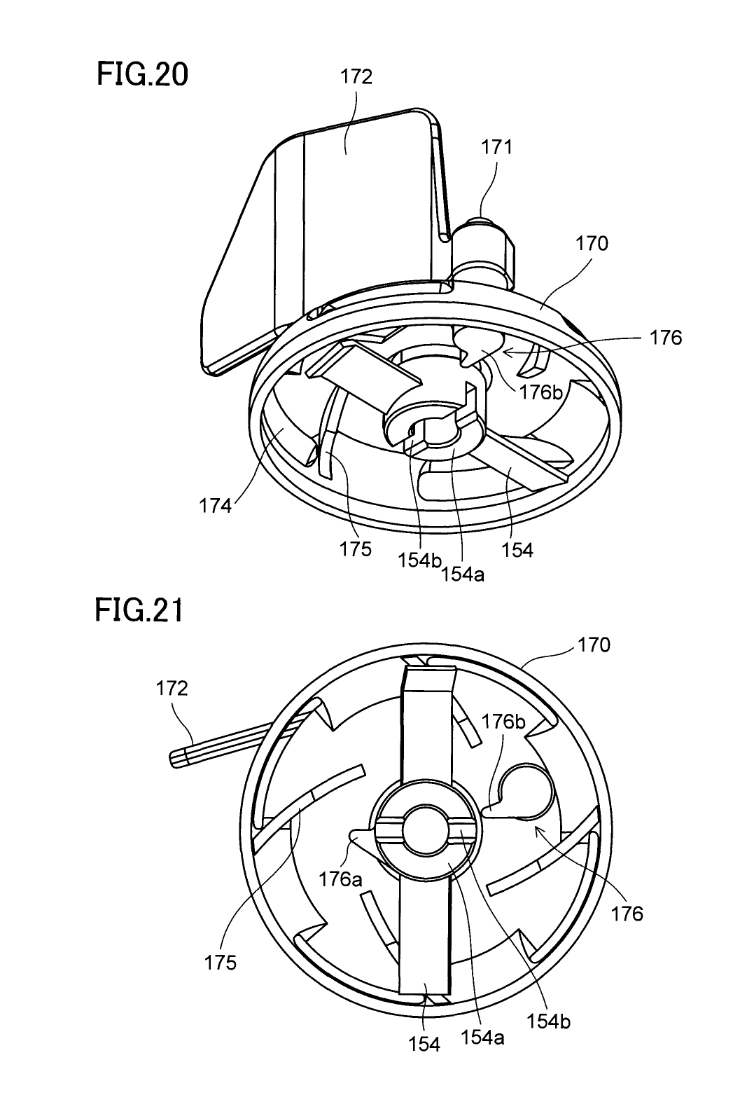

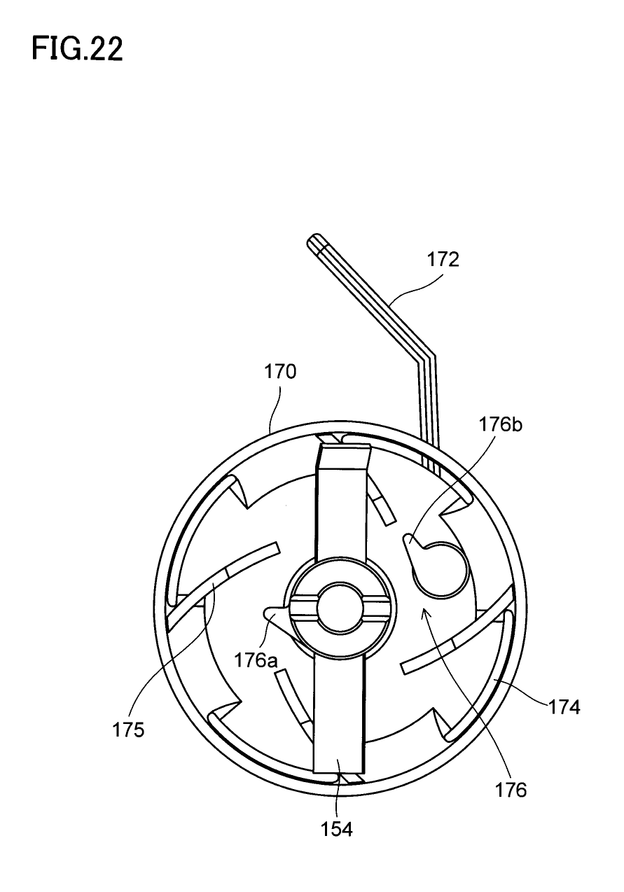

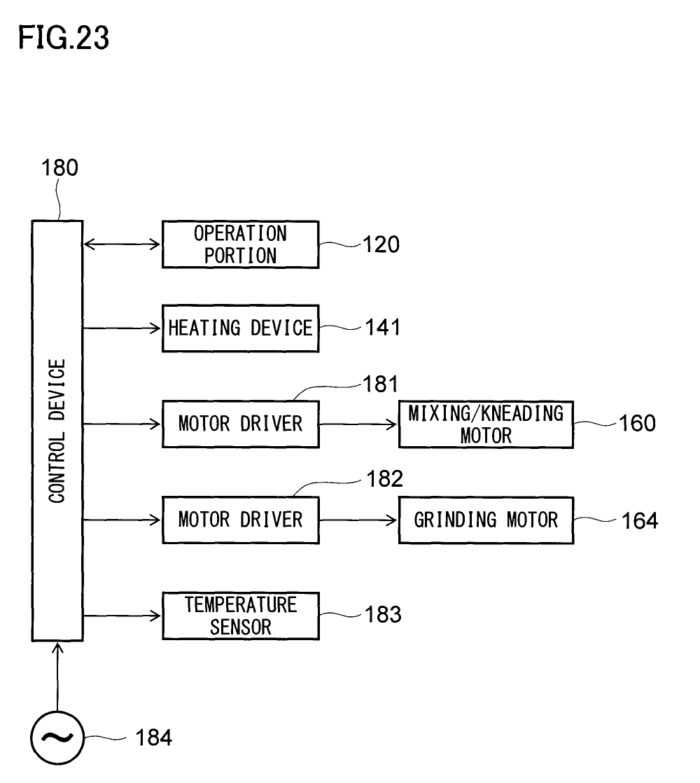

### BRIEF DESCRIPTION OF DRAWINGS

[FIG. 1] A vertical sectional view showing an automatic bread-maker of a first embodiment of the present invention;

[FIG. 2] A vertical sectional view showing the automatic bread-maker of the first embodiment taken along a direction perpendicular to the sectional direction of FIG. 1;

[FIG. 3] A top plan view showing the automatic bread-maker of the first embodiment in a mixing/kneading process;

[FIG. 4] A control block diagram of the automatic bread-maker of the first embodiment;

[FIG. 5] An overall flow chart showing processes in a first example of bread-making process;

[FIG. 6] A flow chart showing a pre-grinding soaking process in the first example of bread-making process;

[FIG. 7] A flow chart showing a grinding process in the first example of bread-making process;

[FIG. 8] A flow chart showing a mixing/kneading process in the first example of bread-making process;

[FIG. 9] A flow chart showing a fermentation process in the first example of bread-making process;

[FIG. 10] A flow chart showing a baking process in the first example of bread-making process;

[FIG. 11] An overall flow chart showing processes in a second example of bread-making process;

[FIG. 12] A flow chart showing a post-grinding soaking process in the second example of bread-making process;

[FIG. 13] An overall flow chart showing processes in a third example of bread-making process;

[FIG. 14] A vertical sectional view showing an automatic bread-maker of a second embodiment of the present invention;

[FIG. 15] A vertical sectional view showing the automatic bread-maker of the second embodiment taken along a direction perpendicular to the sectional direction of FIG. 14;

[FIG. 16] A top plan view showing a bread container of the automatic bread-maker of the second embodiment in a mixing/kneading process;

[FIG. 17] A top plan view showing the bread container of the automatic bread-maker of the second embodiment in a grinding process;

[FIG. 18] A perspective view showing a cover included in the automatic bread-maker of the second embodiment and having a mixing/kneading blade attached thereto;

[FIG. 19] A side view showing the cover included in the automatic bread-maker of the second embodiment and having the mixing/kneading blade attached thereto;

[FIG. 20] A perspective view as seen from below showing the cover included in the automatic bread-maker of the second embodiment and having the mixing/kneading blade attached thereto;

[FIG. 21] A bottom plan view showing the cover included in the automatic bread-maker of the second embodiment and having the mixing/kneading blade attached thereto;

[FIG. 22] A bottom plan view showing the cover in the automatic bread-maker of the second embodiment when the mixing/kneading blade is in an open posture; and

[FIG. 23] A control block diagram of the automatic bread-maker of the second embodiment.

### DESCRIPTION OF EMBODIMENTS

Hereinafter, first and second embodiments of the automatic bread-maker of the present invention will be described with reference to the drawings.

### First Embodiment

First, the structure of an automatic bread-maker of the first embodiment will be described with reference to FIGS. 1 to 4. In FIG. 1, the left side is the front (facade) side of the automatic bread-maker 1, and the right side is the rear (back) side of the same. The left-hand side and the right-hand side of an observer facing the front of the automatic bread-maker 1 are the left side and the right side, respectively, of the automatic bread-maker 1.

The automatic bread-maker 1 has a box-shaped body 10 formed with an external shell made of a synthetic resin. To an upper portion of the body 10, a handle 11 for carrying is attached. An operation portion 20 is provided in a front portion of an upper surface of the body 10. The operation portion 20 is, as shown FIG. 3, provided with: a group of operation keys 21 including keys such as a key for selecting bread type (wheat bread, rice bread, bread with optional ingredient), a cooking program selection key, a timer key, a start key, and a cancellation key; and a display portion 22 that displays a description of a set cooking program and time set through the timer key. The display portion 22 is formed with, for example, a liquid crystal display panel.

A portion of the top surface of the body behind the operation portion 20 is covered with a lid 30 made of a synthetic resin. The lid 30 is hinged to a rear edge of the body 10 with an unillustrated hinge shaft, to be swingable around the hinge shaft within a vertical plane.

Inside the body 10, a baking chamber 40 is provided. The baking chamber 40 is made of a sheet metal and has an open top through which a bread container 50 is put thereinto. The baking chamber 40 has a peripheral side wall 40a which is rectangular in horizontal section and a bottom wall 40b.

Inside the body 10, a base 12 made of a sheet metal is placed. On the base 12, there is fixed a bread container support portion 13, which is made by die casting an aluminum alloy, to a position corresponding to a position in the center of the baking chamber 40. The inside of the bread container support portion 13 is exposed to the inside of the baking chamber 40.

At a position in the center of the bread container support portion 13, a drive shaft 14 is vertically supported. To a lower end of the drive shaft 14, a pulley 15 is fixed. The pulley 15 is made to rotate by a motor 60 supported by the base 12. The motor 60 has a vertical shaft, and has an output shaft 61 protruding from a lower surface thereof. To the output shaft 61, there is fixed a pulley 62, which is coupled to the pulley 15 via a belt 63. The bread container support portion 13 receives a cylindrical pedestal 51 which is fixed to a bottom surface of the bread container 50, and thereby supports the bread container 50. The pedestal 51 is also made by die casting an aluminum alloy.

The bread container 50 is made of a metal sheet in a bucket-like shape and provided with a carrying handle (not shown) attached to a rim of an opening thereof. The bread container 50 is rectangular with rounded corners in horizontal section. At a position in the center of a bottom portion of the bread container 50, a vertical blade rotation shaft 52 is vertically supported, with sealing applied thereto. To the blade rotation shaft 52, a rotational force is transmitted from the drive shaft 14 via a coupling 53. The coupling 53 is formed of two members, one of which is fixed to a lower end of the blade rotation shaft 52 and the other of which is fixed to an upper end of the drive shaft 14. The entirety of the coupling 53 is enclosed by the pedestal 51 and the bread container support portion 13.

Unillustrated protrusions are formed on an internal peripheral surface of the bread container support portion 13 and on an outer peripheral surface of the pedestal 51. These protrusions form a known bayonet coupling. Specifically, in attaching the bread container 50 to the bread container support portion 13, the bread container 50 is brought down such that the protrusions of the pedestal 51 do not interfere with the protrusion of the bread container support portion 13. Then, after the pedestal 51 is fitted into the bread container support portion 13, the bread container 50 is horizontally turned, so that the protrusions of the pedestal 51 are engaged with lower surfaces of the protrusions of the bread container support portion 13, as a result of which the bread container 50 is fixed such that it cannot be pulled out upward. This operation also accomplishes coupling of the coupling 53. The bread container 50 is twisted, when being set, in the same direction as the rotation direction of a mixing/kneading blade which will be described later, so that rotation of the mixing/kneading blade does not cause the bread container 50 to come off

A heating device 41 arranged inside the baking chamber 40 surrounds the bread container 50 and applies heat to bread ingredients. The heating device 41 is formed with a sheath heater.

The blade rotation shaft 52 has a grinding blade 54 unrotatably attached thereto. The grinding blade 54 is made of stainless steel and shaped like a propeller of an airplane. In a bottom portion of the bread container 50, a recess 55 is formed to be circular in plan view, and the grinding blade 54 rotates inside the recess 55.

A center portion of the grinding blade 54 is formed as a hub 54a, and in a lower surface of the hub 54a, a groove (not shown) is formed across the hub 54a in a diameter direction thereof. An unillustrated pin horizontally penetrating the blade rotation shaft 52 receives the hub 54a and engages with the groove to unrotatably couple the hub 54a to the blade rotation shaft 52. The grinding blade 54 is able to be easily pulled out of the blade rotation shaft 52, and this facilitates cleaning after a bread making operation and replacement of a dull grinding blade 54 with a new one.

To an upper end of the blade rotation shaft 52, a mixing/kneading blade 70 is attached. The mixing/kneading blade is also made by die casting an aluminum alloy, and includes a hub 71 fitted to the blade rotation shaft 52, a horizontal disc 72 provided under the hub 71, and a blade 73 that stands upright on an upper surface of the disc 72 and is “<”-shaped in plan view. The disc 72 is slightly smaller in diameter than the recess 55, and substantially conceals the recess 55.

An unillustrated unidirectional clutch is provided between the hub 71 of the mixing/kneading blade 70 and the blade rotation shaft 52. The unidirectional clutch couples the blade rotation shaft 52 and the mixing/kneading blade 70 to each other when the blade rotation shaft 52 rotates counterclockwise in FIG. 3, and uncouples the blade rotation shaft 52 and the mixing/kneading blade 70 from each other when the blade rotation shaft 52 rotates clockwise in FIG. 3.

The hub 71 is also able to be easily pulled out of the blade rotation shaft 52, and this facilitates cleaning of the mixing/kneading blade 70 after a bread making operation.

Operation of the automatic bread-maker 1 is controlled by a control device 80 shown in FIG. 4. The control device 80 is formed of a circuit board appropriately located within the body 10 (preferably at a place where it is least affected by heat from the baking chamber 40). To the control device 80, the operation portion 20 and the heating device 41 are connected, and further, a motor driver 81 of the motor 60 and a temperature sensor 83 are also connected to the control device 80. The temperature sensor 83 is disposed inside the baking chamber 40, and detects temperature of the baking chamber 40. Reference numeral 84 denotes a commercial power supply that supplies power to each component.

Next, a description will be given of a process of making bread from cereal grains by using the automatic bread-maker 1, with reference to FIGS. 5 to 13. FIGS. 5 to 10 show a first example of bread making process.

FIG. 5 is an overall flow chart of the first example of bread making process. As shown in FIG. 5, in the first example of bread making process, a pre-grinding soaking process #10, a grinding process #20, a mixing/kneading process #30, a fermentation process #40, and a baking process #50 are performed in this order. Now, the processes will be described one by one.

The pre-grinding soaking process #10 shown in FIG. 6 starts with step #11 where the user measures cereal grains and puts a certain amount of cereal grains in the bread container 50. As the cereal grains, rice is the most available, but grains of other cereals such as wheat, barley, foxtail millet, Japanese barnyard millet, buckwheat (soba), and corn may be used.

In step #12, the user measures liquid and puts a certain amount of liquid in the bread container 50. The liquid is typically water, but it may be a soup stock which contains a taste component, or it may be fruit juice. The liquid may contain alcohol. Step #11 and step #12 may be performed in a reverse order.

The cereal grains and the liquid may be put in the bread container 50 with the bread container 50 placed outside or inside the baking chamber 40.

After the cereal grains and the liquid are put into the bread container 50 inside the baking chamber 40, or after the bread container 50 in which the cereal grains and the liquid is put outside the baking chamber 40 is attached to the bread container support portion 13, the lid 30 is closed. Here, the user presses a predetermined operation key of the operation portion 20 to start counting how long the cereal grains are soaked in the liquid. At this time point, step #13 starts.

In step #13, a mixture of the cereal grains and the liquid is left to rest in the bread container 50, so that the liquid soaks into the cereal grains. Generally, the higher the liquid temperature is, the faster the cereal grains absorb the liquid, and thus the heating device 41 may be energized to raise the temperature of the baking chamber 40.

In step #14, the control device 80 checks how long the cereal grains and the liquid have been left to rest. The pre-grinding soaking process #10 finishes when the cereal grains and the liquid are found to have been left to rest for a predetermined time. This is informed to the user via a display provided on the operation portion 20, via sound, or the like.

After the pre-grinding soaking process #10, the procedure proceeds to the grinding process #20 shown in FIG. 7. When the user inputs grinding operation data (kind and amount of cereal grains, kind of bread to be baked, etc.) through the operation portion 20 and presses the start key, step #21 starts to be performed.

In step #21, the control device 80 drives the motor 60, to make the blade rotation shaft 52 rotate clockwise in FIG. 3. Then the unidirectional clutch functions to uncouple the mixing/kneading blade 70 from the blade rotation shaft 52, and consequently no torque is imparted to the mixing/kneading blade 70 from the blade rotation shaft 52, and the grinding blade 54 alone rotates together with the blade rotation shaft 52.

Since the cereal grains are ground by the grinding blade 54 after the liquid has soaked into them, it is easy to grind them to their cores. Since the grinding of the cereal grains is performed inside the recess 55, only a minimum amount of grains are scattered outside the bread container.

In step #22, the control device 80 checks whether or not the grinding has been performed according to a set grinding pattern (whether the grinding blade is to be continuously rotated or intermittently rotated interspersed with stop periods, how the intervals should be set and how long a rotation period should last in the case of intermittent rotation, etc.).

When the grinding of the set grinding pattern is found to have been completed, the procedure proceeds to step #23, where the grinding blade 54 finishes rotating, and the grinding process #20 is finished. This is informed to the user via a display provided on the display portion 22, via sound, etc.

In the above description, after the pre-grinding soaking process #10, the grinding process #20 is made to start by the user by operating the operation portion 20; however, the grinding process #20 may be set to automatically start after the pre-grinding soaking process #10 according to grinding operation data inputted by the user either before or in the course of the pre-grinding soaking process #10.

Following the grinding process #20, the procedure proceeds to the mixing/kneading process #30 shown in FIG. 8. At the start of the mixing/kneading process #30, the cereal grains and the liquid in the bread container 50 have become a dough material in a pasty or slurry state. Note that, herein, a substance that is present at the start of the mixing/kneading process #30 is referred to as “dough material,” while a substance becoming increasingly similar to the aimed dough as the mixing/kneading proceeds is referred to as “dough” even before it is completed as dough.

In step #31, the user opens the lid 30 to add a certain amount of gluten to the dough material. Any of seasonings such as salt, sugar, and shortening is added to the dough material as necessary. It is also possible to provide the automatic bread-maker 1 with an automatic feeder for gluten and seasonings such that they are fed without bothering the user.

Substantially simultaneously with step #31, the user operates the operation portion 20 to input the kind of bread to be baked and the cooking program to be performed. When the machine is ready, the user presses the start key, to start the bread making operation in which processes are automatically performed in series from the mixing/kneading process #30, to the fermentation process #40, and to the baking process #50.

In step #32, the control device 80 drives the motor 60 to make the blade rotation shaft 52 rotate counterclockwise in FIG. 3. Then the unidirectional clutch operates to couple the mixing/kneading blade 70 to the blade rotation shaft 52, and the mixing/kneading blade 70 rotates together with the blade rotation shaft 52.

Here, the control device 80 energizes the heating device 41 to raise the temperature of the baking chamber 40. As the mixing/kneading blade 70 rotates, the dough material is mixed and kneaded, to be worked into a lump of dough having predetermined elasticity. The mixing/kneading blade 70 swings the dough around and beats it against an internal wall of the bread container 50, and this adds an element of “kneading (folding, pressing and stretching)” to the mixing/kneading process. The dough material inside the recess 55 gradually mixes with the lump of dough mixed and kneaded by the mixing/kneading blade 70.

In step #33, the control device 80 checks how much time has elapsed since the start of the rotation of the mixing/kneading blade 70. When a predetermined period time is found to have elapsed, the procedure proceeds to step #34.

In step #34, the user opens the lid 30 to add yeast to the dough. The yeast added to the dough here is dry yeast. Instead of yeast, baking powder may be used. It is also possible to adopt an automatic feeder for yeast or baking powder as well, to thereby save the user time and trouble.

In step #35, the control device 80 checks how much time has elapsed since the addition of yeast to the dough. When a period of time necessary to obtain desired dough is found to have elapsed, the procedure proceeds to step #36, where the mixing/kneading blade 70 finishes rotating. At this time, a lump of dough having required elasticity is completed. The disc 72 stops the dough from going into the recess 55, and thus most part of the dough stays above the recess 55, with very small part of the dough, if any, going into the recess 55.

In the case of baking bread with an optional ingredient, at any step in the mixing/kneading process #30, the optional ingredient is added. An automatic feeder can be adopted for optional ingredients, as well.

Following the mixing/kneading process #30, the fermentation process #40 shown in FIG. 9 is performed. In step #41, dough resulting from the mixing/kneading process 30 is placed in a fermentation environment. That is, the control device 80 energized the heating device 41, if necessary, to thereby raise the temperature of the baking chamber 40 to a temperature within a range suitable for fermentation. The user forms the dough into a desired shape and leaves it to rest as necessary.

In step #42, the control device 80 checks how long the dough has been in the fermentation environment. When a predetermined time is found to have elapsed, the fermentation process #40 is finished.

Following the fermentation process #40, the baking process #50 shown in FIG. 10 is performed. In step #51, the dough undergone fermentation is put in a baking environment. That is, the control device 80 supplies the heating device 41 with power necessary for baking bread, and thereby raises the temperature of the baking chamber 40 to a temperature within a bread-baking temperature range.

In step #52, the control device 80 checks how long the dough has been in the baking environment. When a predetermined time is found to have elapsed, the baking process #50 is finished. Here, completion of the bread making is announced in the form of a sign displayed on the display portion 22 or in sound, and in response to the announcement, the user opens the lid 30 and takes out the bread container 50. Then, the user takes the bread out of the bread container 50. Here, a trace of the mixing/kneading blade 70 is left in the bottom of the baked bread when it is taken out of the bread container 50; however, no protrusion in the shape of recess 55 is formed in the bottom of the bread, since the disc 72 has stopped the dough from dropping into the recess 55.

Next, a second example of bread making process will be described based on FIG. 11 and FIG. 12. FIG. 11 is an overall flow chart showing the second example of bread making process. As shown in FIG. 11, in the second example of bread making process, a grinding process #20, a post-grinding soaking process #60, a mixing/kneading process #30, a fermentation process #40, and a baking process #50 are performed in this order. Now, steps in the post-grinding soaking process #60 will be described based on FIG. 12.

In step #61, dough material formed in the grinding process #20 is left to rest in the bread container 50. The dough material here has not undergone the pre-grinding soaking process. While the dough material is left to rest, the liquid soaks into the ground cereal grains. The control device 80 energizes the heating device 41 as necessary to apply heat to the dough material to promote the soaking.

In step #62, the control device 80 checks how long the dough material has been left to rest. When a predetermined time is found to have elapsed, the post-grinding soaking process #60 is finished. When the post-grinding soaking process #60 is finished, the procedure automatically proceeds to the mixing/kneading process #30. The mixing/kneading process #30 and processes performed thereafter are the same as in the first example of bread making process.

Next, a third example of bread making process will be described based on FIG. 13. FIG. 13 is an overall flow chart showing the third example of bread making process. Here, the pre-grinding soaking process #10 of the first example is carried out before a grinding process #20, and the post-grinding soaking process 60 of the second example is performed after the grinding process #20. Then a mixing/kneading process 30 is performed; the mixing/kneading process 30 and processes performed thereafter are the same as in the first example of bread making process.

The grinding blade 54 can be used not only to grind cereal grains but also to break optional ingredients such as nuts and leaf vegetables into small pieces. This makes it possible to bake bread containing small-particle optional ingredients. The grinding blade 54 can also be used, for example, to grind foodstuff other than optional ingredients for bread, or to grind crude drug materials.

In this embodiment, the single control device 80 is able to control the grinding blade 54 and the mixing/kneading blade 70 to rotate in association with each other, and thus, it is possible to impart rotation to the grinding blade 54 and the mixing/kneading blade 70 according to the kind and the amount of cereal grains in the stage of grinding cereal grains and in the stage of mixing/kneading the cereal flour resulting from the grinding, to thereby improve the quality of bread.

### Second Embodiment

Next, the structure of an automatic bread-maker of a second embodiment will be described with reference to FIGS. 14 to 23. In FIG. 14, the left side is the front (facade) side of the automatic bread-maker 100, and the right side is the rear (back) side of the automatic bread-maker 100. The left-hand side and the right-hand side of an observer facing the front of the automatic bread-maker 100 are the left side and the right side, respectively, of the automatic bread-maker 100.

The automatic bread-maker 100 has a box-shaped body 110 formed with an external shell made of a synthetic resin. An operation portion 120 is provided in an upper front portion of the body 110. Although not illustrated in the figures, the operation portion 120 is provided with: a group of operation keys such as a key for selecting the type of bread (wheat bread, rice bread, bread with optional ingredients, etc.), a cooking program selection key, a timer key, a start key, and a cancellation key; and a display portion that displays a description of a set cooking program and time set through the timer key. The display portion is formed with a liquid crystal display panel and a display lamp including a light emitting diode as its light source.

A portion of the top surface of the body behind the operation portion 120 is covered with a lid 130 made of a synthetic resin. The lid 130 is hinged to a rear-side edge of the body 110 with an unillustrated hinge shaft, to be swingable around the hinge shaft within a vertical plane.

Inside the body 110, a baking chamber 140 is provided. The baking chamber 140 is made of a sheet metal and has an open top through which a bread container 150 is put thereinto. The baking chamber 140 has a peripheral side wall 140a which is rectangular in horizontal section and a bottom wall 140b.

Inside the body 110, a base 112 made of a sheet metal is placed. On the base 112, there is fixed a bread container support portion 113 at a position corresponding to a position in the center of the baking chamber 40. The bread container support portion 113 is made by die casting an aluminum alloy. The inside of the bread container support portion 113 is exposed to the inside of the baking chamber 140.

At a position in the center of the bread container support portion 113, a drive shaft 114 is vertically supported. It is pulleys 115, 116 that impart rotation to the drive shaft 114. Clutches are arranged one between the pulley 115 and the drive shaft 114 and one between the pulley 116 and the drive shaft 114 such that, when the pulley 115 is made to rotate in a direction to transmit the rotation to the drive shaft 114, the rotation of the drive shaft 114 is not transmitted to the pulley 116, while, when the pulley 116 is made to rotate in a direction opposite to the direction in which the pulley 115 is made to rotate, to transmit the rotation to the drive shaft 114, the rotation of the drive shaft 114 is not transmitted to the pulley 115.

The pulley 115 is made to rotate by a mixing/kneading motor 160 supported by the base 112. The mixing/kneading motor 160 has a vertical shaft, and has an output shaft 161 protruding from a lower surface thereof. To the output shaft 161, there is fixed a pulley 162, which is coupled to the pulley 115 via a belt 163. The mixing/kneading motor 160 itself is a low-speed high-torque motor, and moreover, the pulley 162 makes the pulley 115 rotate at a reduced speed, and thus the drive shaft 114 rotates at a low speed and with a high torque.

The pulley 116 is made to rotate by a grinding motor 164 which is also supported by the base 112. The grinding motor 164 also has a vertical shaft, and has an output shaft 165 protruding from an upper surface thereof. To the output shaft 165, there is fixed a pulley 166, which is coupled to the pulley 116 via a belt 167.

The grinding motor 164 undertakes a role of imparting high-speed rotation to a later-described grinding blade. Thus, a high-speed rotation motor is chosen as the grinding motor 164, and the speed reduction ratio between the pulley 166 and the pulley 116 is set to approximately 1:1.

The bread container support portion 113 receives a cylindrical pedestal 151 which is fixed to a bottom surface of the bread container 150, and thereby supports the bread container 150. The pedestal 151 is also made by die casting an aluminum alloy.

The bread container 150 is made of a metal sheet in a form like a bucket, with a handle for carrying (not shown) attached to a rim of an opening thereof. The bread container 150 is rectangular with rounded corners in horizontal section. At a position in the center of a bottom portion of the bread container 150, a vertical blade rotation shaft 152 is vertically supported, with sealing applied thereto. To the blade rotation shaft 152, a rotational force is transmitted from the drive shaft 114 via a coupling 153. The coupling 153 is formed of two members, one of which is fixed to a lower end of the blade rotation shaft 152 and the other of which is fixed to an upper end of the drive shaft 114. The entirety of the coupling 153 is enclosed by the pedestal 151 and the bread container support portion 113.

Unillustrated protrusions are formed on an internal peripheral surface of the bread container support portion 113 and on an outer peripheral surface of the pedestal 151. These protrusions form a known bayonet coupling. Specifically, in attaching the bread container 150 to the bread container support portion 113, the bread container 150 is brought down such that the protrusions of the pedestal 151 do not interfere with the protrusions of the bread container support portion 113. Then, after the pedestal 151 is fitted into the bread container support portion 113, the bread container 150 is horizontally turned, so that the protrusions of the pedestal 151 are engaged under the protrusions of the bread container support portion 113, as a result of which the bread container 150 is fixed such that it cannot be pulled out upward. This operation also accomplishes coupling of the coupling 153. The bread container 150 is twisted, when being set, in the same direction as the rotation direction of a mixing/kneading blade which will be described later, such that rotation of the mixing/kneading blade does not cause the bread container 150 to come off.

A heating device 141 placed inside the baking chamber 140 surrounds the bread container 150 and applies heat to the bread ingredients. The heating device 141 is formed with a sheath heater.

The blade rotation shaft 152 has a grinding blade 154 attached thereto at a position slightly above the bottom portion of the bread container 150. The grinding blade 154 is unrotatable with respect to the blade rotation shaft 152. The grinding blade 154 is made of stainless steel, and as shown in FIGS. 20 and 21, shaped like a propeller of an airplane.

A center portion of the grinding blade 154 is formed as a hub 154a that is fitted to the blade rotation shaft 152. In a lower surface of the hub 154a, a groove 154b is formed across the hub 154a in a diameter direction thereof. An unillustrated pin horizontally penetrating the blade rotation shaft 152 receives the hub 154a and engages with the groove 154b to unrotatably couple the grinding blade 154 to the blade rotation shaft 152. The grinding blade 154 is able to be easily pulled out of the blade rotation shaft 152, and this facilitates cleaning after a bread making operation and replacement of a dull grinding blade 154 with a new one.

To an upper end of the blade rotation shaft 152, a dome-shaped cover 170 having a circular shape in plan view is attached. The cover 170 is made by die casting an aluminum alloy, and covers up the grinding blade 154. The cover 170 is rotatably fitted to the blade rotation shaft 152, and is received by the hub 154a of the grinding blade 154. The cover 170 is also able to be easily pulled out of the blade rotation shaft 152, and this facilitates cleaning after a bread making operation.

A mixing/kneading blade 172 having a “<” shape in plan view is attached to an external surface of the cover 170 via a vertical support shaft 171 arranged at a place away from the blade rotation shaft 152. The mixing/kneading blade 172 is also made by die casting an aluminum alloy. The support shaft 171 is fixed to or integrally formed with the mixing/kneading blade 172, and moves with the mixing/kneading blade 172.

The mixing/kneading blade 172 rotates, with the support shaft 171 as a center, in a horizontal plane, with respect to the cover 170, and takes two postures, namely, a folded posture shown in FIG. 16 and an open posture shown in FIG. 17. In the folded posture, the mixing/kneading blade 172 is in contact with a stopper portion 173 formed in the cover 170, so that the mixing/kneading blade 172 is prevented from further rotating clockwise with respect to the cover 70. At this time, a tip end of the mixing/kneading blade 172 slightly protrudes from the cover 170. In the open posture, the mixing/kneading blade 172 is away from the stopper portion 173, and the tip end of the mixing/kneading blade 172 much protrudes from the cover 170.

In the cover 170, there is formed a window 174 through which a space inside the cover and a space outside the cover communicate with each other. The window 174 is located as high as or above the grinding blade 153. In this embodiment, four windows are formed as the window 174 to be arranged at intervals of 90°, but any number of windows may be arranged at any intervals.

As shown in FIGS. 20 and 21, on an internal surface of the cover 170, a total of four ribs 175 are formed corresponding to the windows 174 on a one-to-one basis. Each of the ribs 175 extends obliquely with respect to a radius direction of the cover 170 from near a center of the cover 170 to a circumferential annular wall of the cover 170, the four ribs 175 being arranged in a kind of tomoe-formation (a formation that looks like a fan impeller). Furthermore, the ribs 175 are each curved such that a side thereof which faces the bread ingredients rushing thereto is convex. The grinding blade 154 rotates so close to lower edges of the ribs 175 that the grinding blade 154 almost shaves the lower edges of the ribs 175.

A clutch 176 (see FIG. 21) is provided between the cover 170 and the blade rotation shaft 152. The clutch 176 couples the cover 170 to the blade rotation shaft 152 in a direction in which the blade rotation shaft 152 rotates when the mixing/kneading motor 160 makes the drive shaft 114 rotate (hereinafter, rotation in this direction will be referred to as “forward rotation”). On the other hand, in a direction in which the blade rotation shaft 152 rotates when the grinding motor 164 makes the drive shaft 114 rotate (hereinafter, rotation in this direction will be referred to as “backward rotation”), the clutch 176 uncouples the cover 170 from the blade rotation shaft 152. Incidentally, in FIGS. 16 and 17, the “forward rotation” is a counterclockwise rotation and the “backward rotation” is a clockwise rotation.

The clutch 176 is composed of a first engagement body 176a and a second engagement body 176b. The first engagement body 176 is fixed to or integrally formed with the hub 154a of the grinding blade 154, and thus is unrotatably attached to the blade rotation shaft 152. The second engagement body 176b is fixed to or integrally formed with the support shaft 171 of the mixing/kneading blade 172, and changes its angle along with a shift of the posture of the mixing/kneading blade 172.

The clutch 176 changes its coupling state according to the posture of the mixing/kneading blade 172. Specifically, when the mixing/kneading blade 172 is in the folded posture as shown in FIG. 16, the second engagement body 176b is at the angle shown in FIG. 21. At this time, the second engagement body 176b interferes with the rotation path of the first engagement body 176a; when the blade rotation shaft 152 rotates clockwise in FIG. 21, in other words, rotates forward, the first engagement body 176a engages with the second engagement body 176b, and the rotational force of the blade rotation shaft 152 is transmitted to the cover 170 and the mixing/kneading blade 172. When the mixing/kneading blade 172 is in the open posture as shown in FIG. 17, the second engagement body 176b is at an angle shown in FIG. 22. In this state, the second engagement body 176b is withdrawn from the rotation path of the first engagement body 176a; when the blade rotation shaft 152 rotates counterclockwise in FIG. 22, in other words, rotates backward, no engagement occurs between the first engagement body 176a and the second engagement body 176b. Thus, the rotational force of the blade rotation shaft 152 is not transmitted to the cover 170 and the mixing/kneading blade 172.

In a bottom portion of the bread container 150, a recess 155 is formed to accommodate the grinding blade 154 and the cover 170. The recess 155 is circular in plan view, and between an outer peripheral portion of the cover 170 and an internal surface of the recess 155, there is formed a clearance 156 that allows passage of the bread ingredients therethrough.

Operation of the automatic bread-maker 100 is controlled by a control device 180 shown in FIG. 23. The control device 180 is formed of a circuit board appropriately located within the body 110 (preferably at a place where it is least affected by heat from the baking chamber 140). To the control device 180, the operation portion 120 and the heating device 141 are connected, and further, a motor driver 181 of the mixing/kneading motor 160, a motor driver 182 of the grinding motor 164, and a temperature sensor 183 are also connected to the control device 180. The temperature sensor 183 is disposed inside the baking chamber 140, and detects temperature of the baking chamber 140. Reference numeral 184 denotes a commercial power supply that supplies power to each component.

Next, a description will be given of a process of making bread from cereal grains by using the automatic bread-maker 100. Here, the process of making bread from cereal grains by using the automatic bread-maker 100 of the second embodiment is basically the same as the process (shown in FIGS. 5 to 13) of making bread from cereal grains by using the automatic bread-maker 1 of the first embodiment. Thus, the description will be focused on differences resulting from the difference in structure between the automatic bread-maker 100 of the second embodiment and the automatic bread-maker 1 of the first embodiment, and overlapping descriptions will be omitted.

The automatic bread-maker 100 of the second embodiment operates differently from the automatic bread-maker 1 of the first embodiment in the grinding process shown in FIG. 7 and the mixing/kneading process shown in FIG. 8, and the differences will be described below. First, a description will be given of the grinding process shown in FIG. 7. When a user inputs grinding operation data (kind and amount of the cereal grains, kind of bread to be baked, etc.) through the operation portion 120 and presses the start key, step #21 is started.

In step #21, the control device 180 drives the grinding motor 164, to make the blade rotation shaft 152 rotate backward. Then, the grinding blade 154 starts rotating in the mixture of cereal grains and liquid. The cover 170 also follows the blade rotation shaft 152 to start rotating. The direction in which the cover 170 rotates at this time is clockwise in FIG. 16, and the mixing/kneading blade 172, when it is in the folded posture, moves into the open posture on receiving resistance from the mixture of the cereal grains and the liquid. When the mixing/kneading blade 172 has moved into the open posture, the clutch 176 uncouples the cover 170 from the blade rotation shaft 152 by the second engagement body 176b withdrawing from the rotation path of the first engagement body 176a. At the same time, the mixing/kneading blade 170 in the open posture hits an internal wall of the bread container 150 as shown in FIG. 17, to stop the rotation of the cover 170. Thereafter, the blade rotation shaft 152 and the grinding blade 154 rotate backward at high speed. Even though the grinding blade 154 is rotating at high speed, since the cover 170 and the mixing/kneading blade 172 are not moving, the mixture of the cereal grains and the liquid does not swirl in the bread container 150. This helps prevent occurrence of a situation in which a swirl rises along the periphery of the bread container 150 to flow over the bread container 150.

While the cover 170 is not rotating, the grinding blade 154 rotates at a high speed to grind the cereal grains. Since the cereal grains are ground by the grinding blade 154 in a state in which the liquid has soaked thereinto, the cereal grains are easily ground to their cores. The ribs 175 each extending from near the center of the cover 170 to the circumferential annular wall of the cover 170 assist the grinding by reducing the flow of the mixture of the cereal grains and the liquid in the same direction as the rotation direction of the grinding blade 154. That is, the ribs 175 change the flow of the mixture to increase the chances for the mixture to hit against the grinding blade 154. Since the grinding is performed inside the cover 170, the cereal grains are prevented from scattering outside the bread container 150.

The mixture of the ground cereal grains and the liquid is guided by the ribs 175 toward the windows 174, through which the mixture is discharged out of the cover 170. Also, since each of the ribs 175 is curved to protrude on the side thereof which faces the mixture of the cereal grains and the liquid rushing thereto, the mixture of the cereal grains and the liquid is less likely to stay on the surface of each of the ribs 175 and more likely to flow smoothly toward the windows 174.

When the mixture of the cereal grains and the liquid is discharged from inside the cover 170, the mixture of the cereal grains and the liquid present above the recess 155 moves into the recess 155 through the clearance 156 and then moves from the recess 155 into the cover 170. The cereal grains are ground by the grinding blade 154 inside the cover 170, and return to above the recess 155 through the windows 174 of the cover 170. By grinding the cereal grains while making them circulate in this way, it is possible to efficiently grind the cereal grains. The provision of the ribs 175 allows the ground substance produced by the grinding blade 154 to be quickly guided to the windows 174 without remaining in the cover 170, and this further improves the grinding efficiency.

Since the windows 174 are located at the same height as or higher than the grinding blade 153, the mixture of the ground cereal grains and the liquid is discharged out of the cover 170 in a horizontal or obliquely upward direction, and this helps promote the circulation of the cereal grains.

In step #22, the control device 180 checks whether or not the grinding has been completed according to a set grinding pattern (whether the grinding blade is to be continuously rotated or intermittently rotated interspersed with stop periods, how the intervals be set and how long a rotation time period should be in the case of intermittent rotation, etc.). When the grinding is found to have been completed according to the set grinding pattern, the procedure proceeds to step #23, where the grinding blade 154 is made to stop rotating, and the grinding process #20 is finished. This is informed to the user via a display provided on the display portion 122, via sound, etc.

Following the grinding process #20, the mixing/kneading process #30 shown in FIG. 10 is carried out. At the start of the mixing/kneading process #30, the cereal grains and the liquid in the bread container 150 have become a dough material in a pasty or slurry state.

In step #31, the user opens the lid 130 to add a certain amount of gluten to the dough material. A seasoning such as salt, sugar, or shortening is added to the dough material as necessary. It is also possible to provide the automatic bread-maker 100 with an automatic feeder for gluten and seasoning such that they are fed without bothering the user.

Substantially simultaneously with step #31, the user operates the operation portion 120 to input the kind of bread to be baked and the cooking program to be performed. When the machine is ready, the user presses the start key, to start the bread making operation in which processes are automatically performed in series from the mixing/kneading process #30, to the fermentation process #40, and to the baking process #50.

In step # 32, the control device 180 drives the mixing/kneading motor 160. When the blade rotation shaft 152 rotates forward, to cause the cover 170 to rotate forward, the mixing/kneading blade 172 receives resistance from the dough material, to convert its posture from the open posture into the folded posture. In response to this, in the clutch 176, the second engagement body 176b moves to be at such an angle as to interfere with the rotation path of the first engagement body 176a, and thereby the clutch 176 couples the cover 170 to the blade rotation shaft 152, so that the cover 170 and the mixing/kneading blade 172 together rotate integrally with the blade rotation shaft 152.

Here, the control device 180 energizes the heating device 141 to raise the temperature of the baking chamber 140. The mixing/kneading blade 172 rotates to mix/knead the dough material, which is thereby worked into a lump of dough having predetermined elasticity. The mixing/kneading blade 172 swings the dough around and beats it against an internal wall of the bread container 150, and this adds an element of “kneading (folding, pressing and stretching)” to the mixing/kneading process.

When the cover 170 rotates, the ribs 175 rotate as well. As the ribs 175 rotate, the dough material inside the cover 170 is quickly discharged through the windows 174, to mix with the lump of dough material mixed and kneaded by the mixing/kneading blade 172.

In step #33, the control device 180 checks how much time has elapsed since the start of the rotation of the mixing/kneading blade 172. When a predetermined period of time is found to have elapsed, the procedure proceeds to step #34.

In step #34, the user opens the lid 130 to add yeast to the dough. The yeast added to the dough here is dry yeast. Instead of yeast, baking powder may be used. It is also possible to adopt an automatic feeder for yeast or baking powder as well, to thereby save the user time and trouble.

In step #35, the control device 180 checks how much time has elapsed since the addition of yeast to the dough. When a period of time necessary to obtain desired dough is found to have elapsed, the procedure proceeds to step #36, where the mixing/kneading blade 172 finishes rotating. At this time, a lump of dough having required elasticity is completed. Most of the dough stays above the recess 155, and only a very small amount thereof is left in the recess 155. In the case of baking bread with an optional ingredient, at any step in the mixing/kneading process #30, the optional ingredient is added. An automatic feeder can be adopted for optional ingredients as well.

Thereafter, in the same manner as with the automatic bread-maker 1 of the first embodiment, the fermentation process #40 (see FIG. 9) and the baking process (see FIG. 10) are carried out to bake bread. Here, a trace of the mixing/kneading blade 172 is left in the bottom of resulting bread when it is taken out of the bread container 150; however, as to the cover 170, since it is accommodated in the recess 155 and thus does not protrude from the bottom portion of the bread container 150, it doesn't leave a large trace in the bottom of the bread.

In the same manner as with the automatic bread-maker 1 of the first embodiment, the grinding blade 154 of the automatic bread-maker 100 of the second embodiment is able to be used not only to grind cereal grains but also to break optional ingredients such as nuts and leaf vegetables into small pieces. This makes it possible to bake bread containing a small-particle optional ingredient. The grinding blade 154 can also be used, for example, to grind foodstuff other than optional ingredients for bread or to grind crude drug materials.

In this embodiment as well, the single control device 180 is able to control the grinding blade 154 and the mixing/kneading blade 172 to rotate in association with each other, and thus, it is possible to impart rotation to the grinding blade 154 and the mixing/kneading blade 172 according to the kind and the amount of the cereal grains in the stage of grinding cereal grains and in the stage of mixing/kneading the cereal flour resulting from the grinding, to improve the quality of bread.

### Others

It should be understood that the first and second embodiments of automatic bread-makers specifically described above are not meant to limit the present invention, and that the present invention can be practiced with many modifications within the spirit of the present invention.

### INDUSTRIAL APPLICABILITY

The present invention is widely applicable to automatic bread-makers for use mainly in general households.

### LIST OF REFERENCE SYMBOLS

1, 100 automatic bread-maker
10, 110 body
40, 140 baking chamber
50, 150 bread container
52, 152 blade rotation shaft
54, 154 grinding blade
55, 155 recess
60 motor
70, 172 mixing/kneading blade
72 disc
156 clearance
160 mixing/kneading motor
164 grinding motor
170 cover
174 window
176 clutch

1-8. (canceled)

9. An automatic bread-maker, comprising:
a bread container in which bread ingredients are put;
a baking chamber which is provided inside a body and accommodates the bread container;
a blade rotation shaft which is provided at a bottom portion of the bread container;
a grinding blade which is fitted to the blade rotation shaft;
a mixing/kneading blade which is arranged above the grinding blade; and
a motor which imparts a rotational force to the blade rotation shaft,
wherein
a recess is so formed in a bottom portion of the bread container as to surround the blade rotation shaft, and the grinding blade rotates inside the recess.

10. The automatic bread-maker of claim 9,
wherein
the grinding blade is unrotatably attached to the blade rotation shaft;
the mixing/kneading blade is fitted to the blade rotation shaft such that the mixing/kneading blade rotates above the recess; and,
between the mixing/kneading blade and the blade rotation shaft, there is provided a clutch which couples the mixing/kneading blade and the blade rotation shaft to each other or uncouples the mixing/kneading blade and the blade rotation shaft from each other.

11. The automatic bread-maker of claim 10,
wherein
the clutch is a unidirectional clutch which couples the mixing/kneading blade and the blade rotation shaft to each other when the blade rotation shaft rotates in one direction, and which uncouples the mixing/kneading blade and the blade rotation shaft from each other when the blade rotation shaft rotates in a direction opposite to said one direction.

12. An automatic bread-maker of claim 9, wherein a disc which conceals the recess is combined with the mixing/kneading blade.

13. An automatic bread-maker of claim 10, wherein a disc which conceals the recess is combined with the mixing/kneading blade.

14. An automatic bread-maker of claim 11, wherein a disc which conceals the recess is combined with the mixing/kneading blade.

15. The automatic bread-maker of claim 9, further comprising:
a dome-shaped cover which is fitted to the blade rotation shaft, the cover covering the grinding blade and having the mixing/kneading blade formed on an external surface thereof,
wherein
the cover is accommodated in the recess.

16. The automatic bread-maker of claim 15,
wherein
the grinding blade is unrotatably attached to the blade rotation shaft; and,
between the cover and the blade rotation shaft, there is provided a clutch which couples the cover and the blade rotation shaft to each other or uncouples the cover and the blade rotation shaft from each other.

17. The automatic bread-maker of claim 16,
wherein
the clutch couples the cover and the blade rotation shaft to each other when the blade rotation shaft rotates in one direction, and uncouples the cover and the blade rotation shaft from each other when the blade rotation shaft rotates in a direction opposite to said one direction.

18. The automatic bread-maker of claim 15,
wherein,
between an outer peripheral portion of the cover and an internal surface of the recess, there is formed a clearance which allows passage of bread ingredients therethrough; and
the cover has formed therein a window through which a space inside the cover and a space outside the cover communicate with each other.

19. The automatic bread-maker of claim 16,
wherein,
between an outer peripheral portion of the cover and an internal surface of the recess, there is formed a clearance which allows passage of bread ingredients therethrough; and
the cover has formed therein a window through which a space inside the cover and a space outside the cover communicate with each other.

20. The automatic bread-maker of claim 17,
wherein,
between an outer peripheral portion of the cover and an internal surface of the recess, there is formed a clearance which allows passage of bread ingredients therethrough; and
the cover has formed therein a window through which a space inside the cover and a space outside the cover communicate with each other.
